(19) United States
(12) Patent Application Publication
(10) Pub. No.: US 2015/0242786 A1
(43) Pub. Date: Aug. 27, 2015

(54) INTEGRATING PROCESS CONTEXT FROM HETEROGENEOUS WORKFLOW CONTAINERS TO OPTIMIZE WORKFLOW PERFORMANCE

(71) Applicant: INTERNATIONAL BUSINESS MACHINES CORPORATION, Armonk, NY (US)

(72) Inventors: SUBIL M. ABRAHAM, Plano, TX (US); Rajaraman Hariharan, Santa Clara, CA (US); Priyadarshini Sampath, Bangalore, IN (US); Mathews Thomas, Flower Mound, TX (US)

(73) Assignee: INTERNATIONAL BUSINESS MACHINES CORPORATION, Armonk, NY (US)

(21) Appl. No.: 14/186,023

(22) Filed: Feb. 21, 2014

(51) Int. Cl. G06Q 10/06

(52) U.S. Cl. CPC G06Q 10/06316

(57) ABSTRACT

One or more heterogeneous process workflow containers can be identified within a runtime environment. Each of the process workflow containers can include a process instance associated with a workflow. Each instance can include activities and a decision point. One or more automated and manual changes to the activity of the instances associated with the workflow executing within the containers can be captured. The changes can be analyzed to establish an integrated context for the instance. The context can include an input and an output element of the process instance. A recommendation for optimizing the workflow can be computed based on the analyzing.

### BACKGROUND

The present invention relates to the field of change management and workflow automation and, more particularly, to integrating process context from heterogeneous workflow containers to optimize workflow performance.

Workflows in a business environment enable the sequencing of multiple inter-related tasks to solve needs of the business entity. Some of these inter-related tasks can be automated and some can be human related activities which aid in decision-making and branching during the workflow execution (e.g., a process flow). However, as the needs of a business continues to evolve at a rapid pace, many users of these workflow often tend to perform tasks that are out of sequence or that are not present in the workflow. This is mainly due to a high volume of unstructured activity which is not initially present in the workflow. In some cases, the workflow can include unnecessary activities (e.g., steps) that can have been skipped or can be merged into a single activity to improve the performance of the workflow.

Performance improvements can be difficult to apply to a workflow due to a variety of different contexts (e.g., user input), usage patterns, and/or constraints associated with the workflow execution. Unfortunately, it is currently difficult to capture changes (e.g., user changes to improve performance) in an existing workflow as change capture is a manual action which does not typically account for input from all users across a runtime environment. Consequently, workflows remain sub-optimal even after relevant updates are performed and/or new code is applied because the business needs for the workflow have changed in the interim.

Because business applications which execute the workflows reside within proprietary workflow containers, building an effective integrated context across these multiple containers for the purposes of optimization is extremely difficult. For example, FILENET ECM, UNICA CAMPAIGN, AND BUSINESS PROCESS engine have proprietary containers which execute workflows which include automated activities as well as human activities occur and consequently context information is not effectively captured from these proprietary containers. Therefore, it is desirable to enable a business workflow to be adapted and/or optimized based on the needs of the business and needs of the workflow users.

### BRIEF SUMMARY

One aspect of the present invention can include a system, an apparatus, a computer program product and a method for integrating process context from heterogeneous workflow containers to optimize workflow performance. One or more heterogeneous process workflow containers can be identified within a runtime environment. Each of the process workflow containers can include a process instance associated with a workflow. Each instance can include activities and a decision point conforming to a business process model. One or more automated and manual changes to the activity of the instances associated with the workflow executing within the containers can be captured. The changes can be analyzed to establish an integrated context for the instance. The context can include an input and an output element of the process instance. A recommendation for optimizing the workflow can be computed based on the analyzing.

Another aspect of the present invention can include a method, an apparatus, a computer program product, and a system for integrating process context from heterogeneous workflow containers to optimize workflow performance. An optimization engine can be configured to determine an integrated context for one or more process instances executing within a set of heterogeneous process workflow containers. The context can include an input and/or an output element of the process instance. The process instances can be associated with a workflow. The workflow can be a series of activities conforming to a business process model. A data store can be able to persist a workflow reconfiguration, an external activity metric, and/or a reconfiguration mapping. The reconfiguration mapping can include a workflow identifier, a process container identifier, and a change configuration identifier.

### BRIEF DESCRIPTION OF THE SEVERAL VIEWS OF THE DRAWINGS

FIG. 1 is a schematic diagram illustrating a set of phases for integrating process context from heterogeneous workflow containers to optimize workflow performance in accordance with an embodiment of the inventive arrangements disclosed herein.

FIG. 2 is a schematic diagram illustrating a method for integrating process context from heterogeneous workflow containers to optimize workflow performance in accordance with an embodiment of the inventive arrangements disclosed herein.

FIG. 3 is a schematic diagram illustrating a system for integrating process context from heterogeneous workflow containers to optimize workflow performance in accordance with an embodiment of the inventive arrangements disclosed herein.

### DETAILED DESCRIPTION

The present disclosure is a solution for integrating process context from heterogeneous workflow containers to optimize workflow performance. In the solution, a workflow associated with a business process manager can be identified. Changes occurring to one or more process instances associated with the workflow and executing within a set of heterogeneous workflow containers can be captured. Changes can include, but is not limited to, manual processes, automated processes, and the like. For example, a user can explicitly initiate and terminate task change tracking to enable optimization across an integrated context. Changes can be analyzed to determine an integrated context for the process instances which can be leveraged to generate a reconfiguration recommendation. The recommendation can be utilized to optimize the workflow and/or the process instances.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

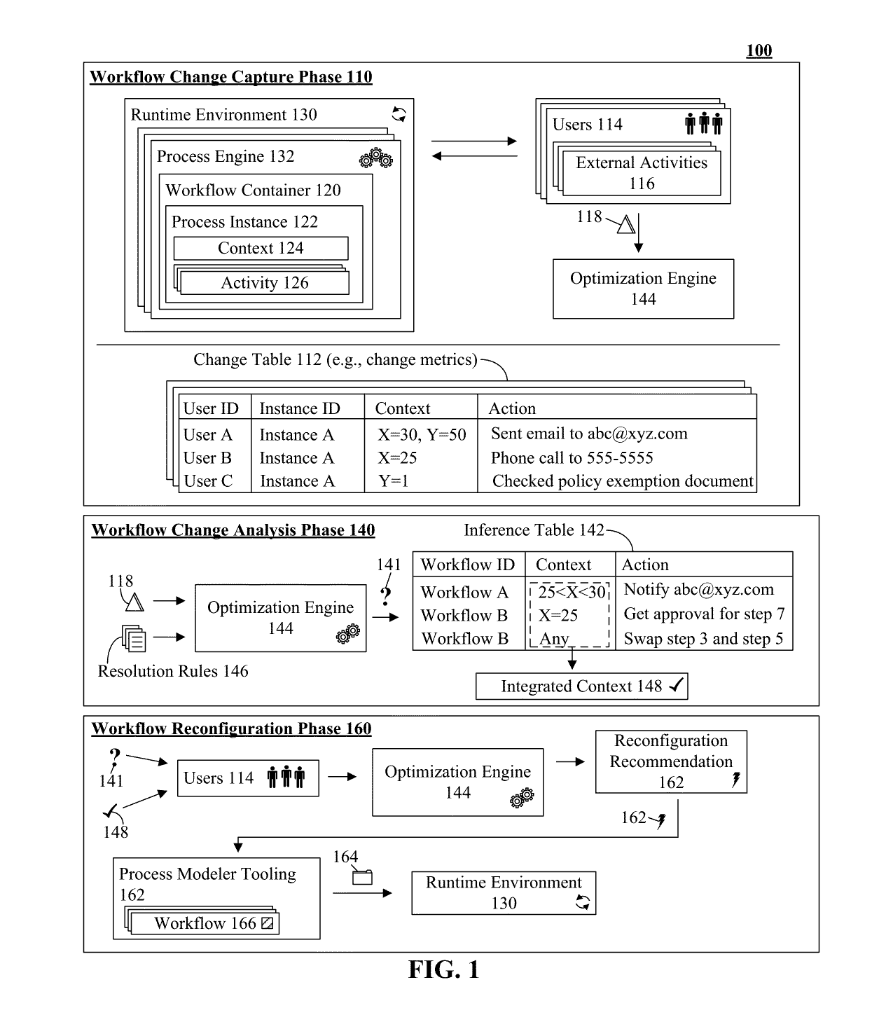

FIG. 1 is a schematic diagram illustrating a set of phases 110-140 for integrating process context from heterogeneous workflow containers to optimize workflow performance in accordance with an embodiment of the inventive arrangements disclosed herein. Phases 110-140 can be one or more phases of a post-execution workflow optimization and/or business process reengineering (BPR) process. Phases 110-140 can include, but is not limited, a workflow change capture phase, a workflow change analysis phase, workflow reconfiguration phase, and the like.

It should be appreciated that currently business workflows have a major limitation which cannot fulfill the dynamic needs of a business when users execute steps that are either out of sequence or not present in a workflow. The disclosure overcomes this limitation to enable a business workflow to capture the behavior of the actors at different stages and introduce points of variance in the flow where patterns can be detected. These points of variance can be present at well-defined places or can be dynamic based on the nature of the work being performed. Workflow 166 and workflow 166 instances such as process instances 122) can represent a series of activities (e.g., activity 126), each representing a task to be performed by a user 114 (e.g., person) or a system (e.g., software component, applications, process engine 132). Workflow 166 and/or process instances 122 can include one or more decision points which can be associated with a condition, a context, and the like.

Runtime environment 130 can manage and execute workflows (e.g., process instances 122) which can involve several users 114 and systems (e.g., optimization engine 144) at an enterprise level. Environment 130 can include components (e.g., process engine 132) to manage, deploy, monitor, and/or execute multiple workflows (e.g., process instances 122). Environment 130 can handle multiple instances 122 of each deployed workflow 166. For example, each workflow 166 can be deployed as a process instance 122 within one or more workflow containers 120, enabling the workflow 166 to be utilized by many users 114. The sequence of steps (e.g., activities 122) specified in each workflow can be executed by a combination of user 114 and/or Information Technology (IT) systems until the workflow 166 completes.

The disclosure proposes a functionality (e.g., functionality of engine 144) which can determine changes required to a workflow based on user 114 activity (e.g., external activities 116) and perform necessary updates to the existing workflow. The disclosure functionality can be built as part of an existing workflow system or as an external component which can interface with an existing workflow system.

The disclosure functionality can build an integrated context across multiple workflow business application containers (e.g., container 120). Further, the disclosure functionality can dynamically create, modify, and/or delete workflows based on user preferences, user defined flows, repeatable patterns, and/or monitoring of the workflow. Workflow 166 can be personalized for a specific user (e.g., user 114) or can be customized for a user group. The functionality of the disclosure can permit workflow optimization based on user preferences, user defined flows, repeatable patterns and monitoring of workflows to expedite workflow steps. Optimization can be implemented at specific user level or aggregated to group level. The functionality can enable a workflow which can dynamically modify itself based on learned behavior of current and/or past user behavior and/or changes in the environment (e.g., runtime environment 130). In one instance, the disclosure can reassign ownership of individual steps in a workflow to different actors based on a learned behavior. In another instance, the disclosure can dynamically force parallel steps in a workflow to become sequential based on a learned behavior. In yet another instance, the disclosure can dynamically combine individual workflow steps into a single step based on business needs.

In one embodiment, the disclosure can dynamically link two or more independent business workflows into a single larger workflow based on business requirements. In the embodiment, engine 144 can intelligently determine decision points which can connect the independent business workflows together. In another embodiment, the disclosure can self-monitor a workflow and dynamically add event points to alert the administrator of any unusual new patterns. In yet another embodiment, the disclosure can automatically synchronize changes made in a business process execution model (e.g., post deployment) back to a process modeler (e.g., tooling 162).

In workflow change capture phase 110, users 114 can interact with process instances 122. In one instance, changes 118 from users 114 performing external activities 116 related to a process instance 122 can be conveyed to an optimization engine 144. Some techniques for capturing user behavior (e.g., activities 116) and consequently changes 118 can include direct data capture, indirect data capture, manual and/or automated data capture processes, and the like.

During the workflow change capture phase 110, the system can capture the details of a change or an update that can be required to a workflow 166. It should be appreciated that, a final decision (e.g., user approval) on required changes is not necessarily performed in this phase, hence the data captured at this phase is used to generate a one or more potential changes (e.g., table 142) that can be required in a workflow 166.

While a workflow is executing, users 114 can perform an action to suggest a change to the workflow being executed. For example, changes to process instance 122 by users can be tracked and analyzed to determine a relevant change which can be enacted. Any external activities 116 performed by the user to fulfill a workflow task, that is not explicitly captured in the workflow, can be treated by the disclosure as a potential change required to the workflow. These deviations can be captured in this phase to enable determination of changes to the workflow. This is part of an integrated context capability where external tasks 116 performed by the user 114 in different workflow engines 132 can be captured to maintain context which can be used in the subsequent phases 140, 160 to make alterations to specific workflows running in different containers 120.

Direct data capture can include a manual and automated data capture process. In one instance, a user 114 can manually start and stop activity 116 tracking. For example, a user can manually initiate a change capture process by selecting a “record” interface button of a step recorder. In one embodiment, a user can explicitly specify a workflow activity is unnecessary utilizing direct data capture. After suggesting the change, the user 114 can proceed to complete a workflow activity. The disclosure (e.g., engine 144) capture the conditions governing the task execution and the change suggested by the user. For example, if a user specifies that a step B is not required, the engine 144 can capture data indicating that the step B is not required, the conditions under which the user suggested this update and any result of the task. That is, the data captured by the system can capture context data such as “step B is not required when input was X and Y”.

In another instance, a user 114 can indicate that a workflow activity can be required but no manual intervention can be required. The disclosure can capture the conditions governing the task execution and the non-manual operation to be performed as a replacement of the human task. For example, the engine 144 can capture that the end result of a task was approved if the input is X and Y and in another execution of the task, the result is a denied if input is X and Z. At this phase 110, only the occurrence of this condition is tracked by the system, which can be used as data for analysis in the next phase 140.

In yet another instance, a user can explicitly specify a set of workflow activities which can be rearranged to improve usability and/or performance. The disclosure can capture the context of the conditions governing the task execution and the change suggested by the user. For example, a user can indicate to the engine 144 that a Workflow A step 3 needs to be performed before step 2 under a particular circumstance by initiating a data capture and performing the reorganization.

Indirect data capture can occur utilizing one or more traditional and/or proprietary entities. In one embodiment, the disclosure can track a set of application, files or external system activity to identify a change required to the workflow. In the embodiment, specific applications can be tracked via well defined application interfaces (e.g., APIs, Web-based service) to identify the changes required. For example, the engine 144 can determine that the user opened an e-mail or instant messenger application to send a message to a colleague and waited for a response before fulfilling the workflow task. In another embodiment, the disclosure can monitor system resources to determine an activity 116 which was performed. For example, engine 144 can be utilized to determine files accessed (e.g., moved/deleted a file) and an external IT system access which was enacted to perform the task. It should be appreciated that the scope of applications and systems which can be monitored can be at the discretion of enterprise, engine 144, and/or the user 114.

During a change capture phase 110, any combination of the possible direct and indirect scenarios can be tracked at the same time. In essence, the change capture phase can capture of one or more actions for a given activity and/or create a persistent data structure (e.g., table 112) with raw data of actions performed by users at various steps during the workflow.

At the end of data capture phase 110, a table 112 containing the data related to all actions performed by the user can be created. Table 112 can include, but is not limited to, a user identifier, an instance identifier, a workflow identifier, a context, an action (e.g., external activity 116) and the like. In one instance, an entry can be created for each change suggested by every user to one or more workflows. In the instance, the table 112 can show captured changes from various workflow systems. In one embodiment, table 112 data can utilized to consolidate contexts to produce an integrated context of all deviations/changes in the runtime environment 130.

It should be appreciated that phase 110 can include graphical data acquisition (e.g., screen capture) which can include manual and/or automated processes. For example, a screen capture can be manually analyzed by a human user to create an activity. In one instance, screen capture can be automatically performed when a user performs an activity out of sequence or not present in a workflow.

It should be understood that the disclosure can permit a user to manually capture steps within in workflow tool (e.g., tooling 162). This tool capture can implicitly link the captured step to an original workflow.

During workflow change analysis phase 140, the engine 144 can analyze the workflow updates that were captured in the previous phase 110 (e.g., change 118) to determine a modification required in each workflow. It should be appreciated that the phase can account for the occurrence of a workflow update, the conditions in which the change was captured, the number of such occurrences, and the like. In one instance, analysis 140 can identify patterns in the captured data. Patterns can include identification of a particular type of change being requested by one or more users, the similarity of the input/context in each case, and the like. In one embodiment, the engine 144 can identify hit and miss conditions in such patterns. For example, when the input variables for a workflow A were X, 55% of users requested a change while 45% of users did not want the change.

It should be appreciated that the sensitivity of the engine 144 can be configured to aid the system in resolving conflicts (e.g., resolution rules 146) to determine an appropriate pattern. For example, a conservative configuration can permit the engine 144 to refrain from performing a workflow change even if a conflict is identified. In another example, the engine 144 can be configured to perform a change only when more than 95% of users want a workflow update (e.g., analysis performed for each individual user to determine the individual user's opinion on the workflow updates that are required). In one embodiment, users 114 can be grouped as appropriate for the enterprise to determine broader patterns of similar workflow changes that are required beyond an individual user level. This pattern recognition analysis can identify similarities of a required change across several users. It should be appreciated that system can be configured so that a change can be suppressed if only few users of a group (e.g., minority) approve the change. It should be understood that group level analysis can be performed for several levels of user grouping.

The analysis can use the integrated context 148 data to determine the changes that are required across the different workflow systems in the organization. The result of phase 140 can be a list of inferences (e.g., decisions) about the change that is required to a workflow. Input such as data captured in the change data capture phase (e.g., 118) and resolution rules 145 can produce an inference table. Inferences captured can have a scope relating to a list of users to whom the change can be applied (e.g., to a single user or a group of users). The output of phase 140 can be an inference table which can include a list of changes required, the user scope and input context for which the inference is suitable, and the like. It should be appreciated that the integrated context 148 can include automatically and/or manually generated data. In one embodiment, integrated context 148 can be subject to user approval permitting refinement of an accurate integrated context.

During workflow reconfiguration phase 160, workflow updates determined by the workflow analysis phase 140 can be implemented. Phase 160 can implement an appropriate workflow change at the right scope as decided by the analysis phase. That is, the change can be propagated to the right set of users and within the right input context. Inference table 142 built in analysis phase 140 can be used to introduce changes to the existing workflow implementation. Types of changes can include addition of new workflow steps, deletion of existing workflow steps, skipping of certain steps, changes to order of the work flow steps, and the like. Depending on the disclosure configuration, a supervisory approval can be optionally required before performing updates to a workflow. In one instance, engine 144 can translate a required change to an appropriate notation such as Business Process Execution Language (BPEL), so that the change can be performed to the workflow. In another instance, humans can be leveraged to translate the inferences into a workflow change. A hybrid approach where humans can be used for complex changes while simple changes may be automated is also contemplated.

It should be appreciated that the disclosure (e.g., engine 144) can monitor input parameters and the end result of a workflow task across a period of time to determine optimizations (e.g., update 164) to the task. The system can verify the optimization with a user before enforcing the rule. In one embodiment, an audit log or user notification can be generated by engine 144 when an optimization is executed for security purposes. The optimization can be implemented as a rule, modifications to the workflow, and the like.

Drawings presented herein are for illustrative purposes only and should not be construed to limit the invention in any regard. It should be appreciated that the disclosure can introduce points of variance in a workflow where patterns can be detected while maintaining an integrated context across the entire span of activities. These points of variance can be present at well defined places and/or can be dynamic based on the nature of the work being performed.

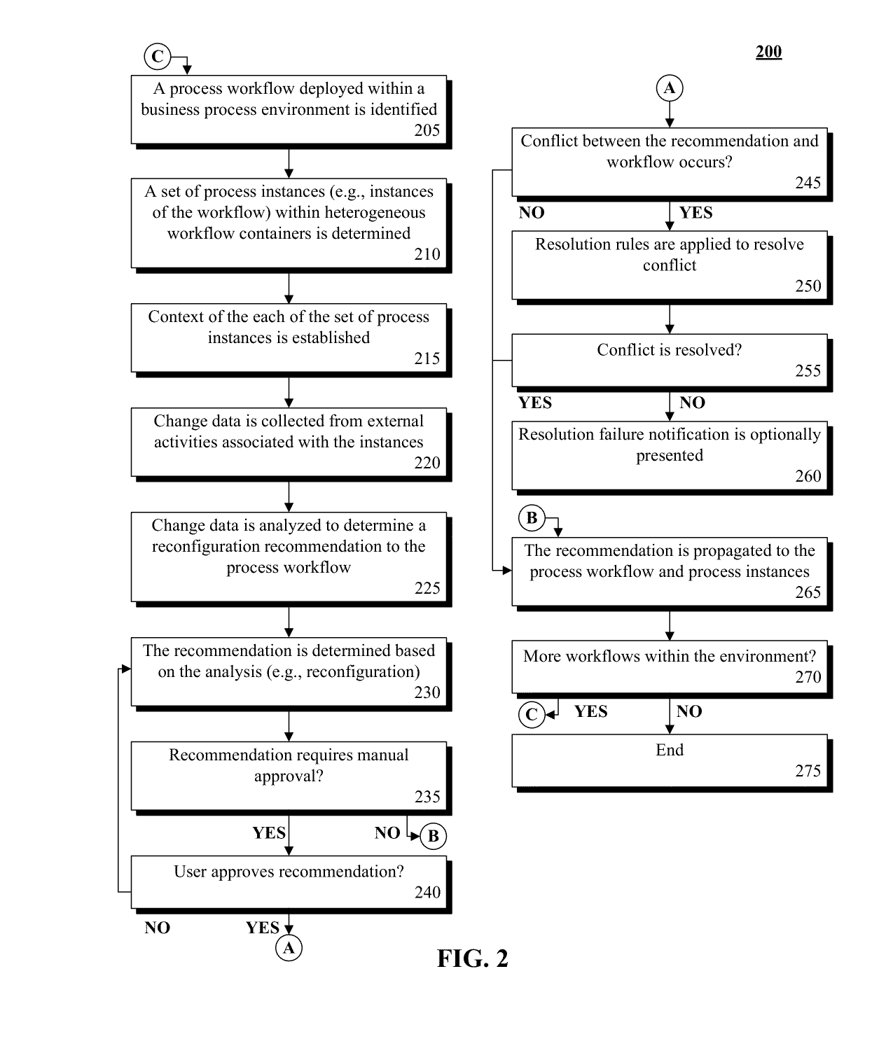

FIG. 2 is a schematic diagram illustrating a method 200 for integrating process context from heterogeneous workflow containers to optimize workflow performance in accordance with an embodiment of the inventive arrangements disclosed herein. In method 200, a process workflow and associated process instances can be optimized based on change data captured from external activities. External activities can be captured manually and/or automatically utilizing traditional and/or proprietary techniques. The optimization can include reconfigurations such as activity insertion, activity deletion, activity merging, and the like.

In step 205, a process workflow deployed within a business process environment can be identified. In step 210, a set of process instances within one or more heterogeneous workflow containers can be determined. In step 215, the context of each of the set of process instances can be established. In one instance, individual contexts of each process can be merged to create an integrated context. In the instance, one or more conflict resolution rules can be applied to create the integrated context. For example, resolution rules can include user preferences which can be utilized to determine context priority (e.g., a process instance context which can override the context of another process instance).

In step 220, change data can be collected from external activities associated with the instances. In step 225, change data can be analyzed to determine a reconfiguration recommendation to the process workflow. In step 230, the recommendation can be determined based on the analysis. In step 235, if the recommendation requires manual approval, the method can continue to step 240, else proceed to step 265. In step 240, if the user approves the recommendation, the method can continue to step 240, else return to step 230. In step 245, if a conflict between the recommendation and the workflow occurs, the method can continue to step 250, else proceed to step 265. In step 250, resolution rules can be applied to resolve the conflict. In step 255, if the conflict is resolved, the method can proceed to step 265, else continue to step 260. In step 260, a resolution failure notification can be optionally presented. In step 265, the reconfiguration can be propagated to the process workflow and/or the process instances. In step 270, if there are more workflows within the environment, the method can return to step 205, else continue to step 272. In step 275, the method can end.

Drawings presented herein are for illustrative purposes only and should not be construed to limit the invention in any regard. It should be appreciated that method 200 can be performed in real-time or near real-time. Further, method 200 can be performed in serial and/or in parallel. It should be appreciated that steps 205-270 can be iteratively performed for each workflow within a business process management environment. In one embodiment, steps 230-240 can include user approval which can be user input used to continually refine a reconfiguration recommendation.

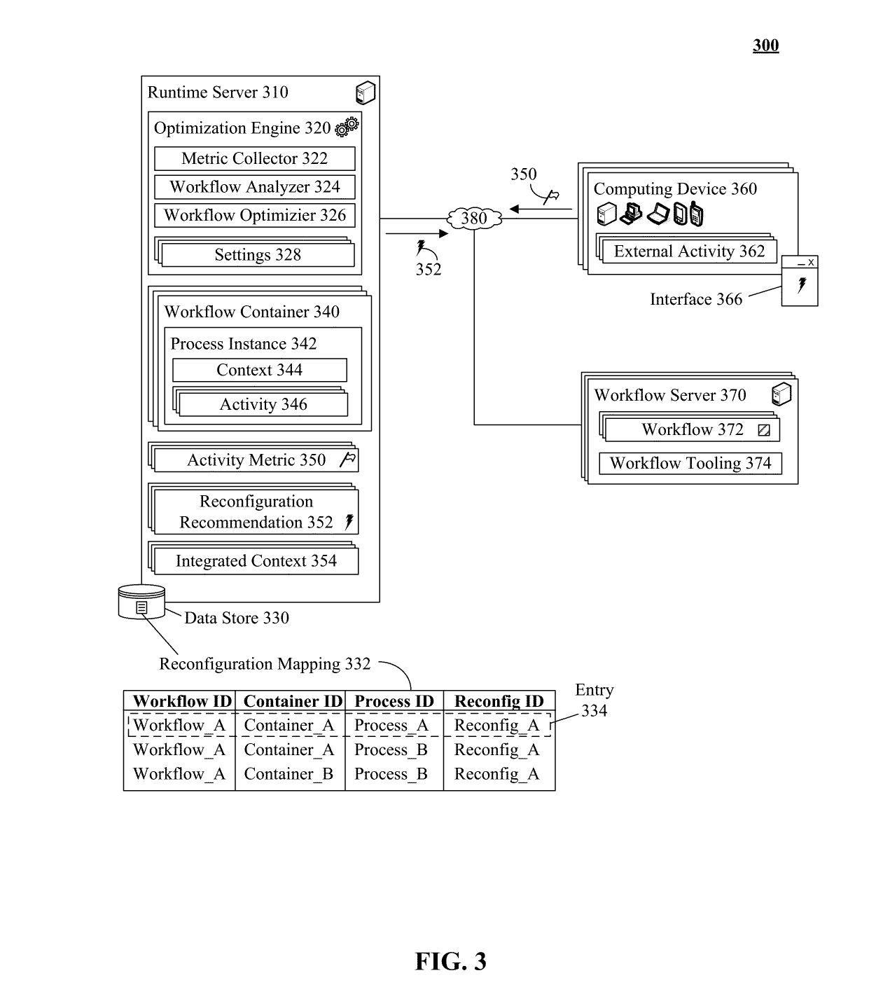

FIG. 3 is a schematic diagram illustrating a system 300 for integrating process context from heterogeneous workflow containers to optimize workflow performance in accordance with an embodiment of the inventive arrangements disclosed herein. In system 300, an integrated context 352 can be determined from process instances 342 across multiple heterogeneous workflow containers 340. Metrics (e.g., 350) can be captured from external activities 362 performed on computer 360. Metrics 350 can be conveyed to engine 320 which can analyze metrics with context 354 to determine one or more reconfiguration recommendations 352 which can optimize workflow 372. A recommendation 352 can be conveyed to device 360 which can present recommendation 352 for approval within interface 366. It should be appreciated that, system 300 components can be communicatively linked via one or more networks 380. It should be understood that process instance 342 can be associated with a workflow 372.

Runtime server 310 can be a hardware/software entity for executing optimization engine 320. Server 310 can include, but is not limited to, optimization engine 320, a workflow container 340, a data store 330, load balancing, and the like. Server 310 functionality can include, but is not limited to, encryption, file sharing, and the like. In one embodiment, server 310 can be a business process runtime environment such as an IBM BUSINESS PROCESS SERVER.

Optimization engine 320 can be a hardware/software element for optimizing workflow 372 based on external activities 362. Engine 320 can include, but is not limited to, a metric collector 322, workflow analyzer 324, workflow optimizer 326, settings 328, and the like. Engine 320 functionality can include, but is not limited to, business process automation, notification capabilities, and the like. In one embodiment, engine 320 can be a functionality of a business process management tooling (e.g., workflow tooling 374).

Metric collector 322 can be a hardware/software entity for collecting one or more metrics associated with external activity 362. Collector 322 functionality can include activity 362 tracking, application tracking, device 360 resource tracking, and the like. In one embodiment, collector 322 can include screen capture capabilities permitting graphical data capture of external activities 362. In the embodiment, automated and manual processes can be utilized to capture metrics associated with external activities 362.

Workflow analyzer 324 can be a hardware/software element for analyzing workflow 372, instance 342, context 344, activity 346, external activity 362, and the like. Analyzer 324 functionality can include, but is not limited to, metric 350 analysis, context 344 integration, and the like. In one embodiment, analyzer 324 can examine captured metrics 350 to determine one or more patterns which can be utilized to generate a recommendation. In one instance, analyzer 324 can determine one or more branch points within a workflow which an integrated context can be established.

Workflow optimizer 326 can be a hardware/software entity for optimizing process instance 342 and/or workflow 372. Optimizer 326 functionality can include, but is not limited to, reconfiguration recommendation 352 generation, reconfiguration mapping 332, and the like. In one embodiment, optimizer 326 can utilize a reconfiguration mapping 332 to enable workflow reconfiguration. In the embodiment, mapping 332 can be utilized to track reconfiguration of a workflow.

Settings 328 can be one or more ruleset for establishing the behavior of server 310, engine 320, and/or system 300. Settings 328 can include, but is not limited to, metric collector 322, workflow analyzer 324, workflow optimizer 326, and the like. In one instance, settings 328 can include security policy options, reconfiguration settings, and the like. Setting 328 can be manually and/or automatically determined. In one instance, setting 328 can be configured via interface 366.

Workflow container 340 can be a business process data structure for executing workflow 372 as process instance 342. Container 340 can include, but is not limited to, process instance 342, control information (e.g., object references), and the like. In one embodiment, container 340 can include, but is not limited to, a FILENET ECM container, UNICA CAMPAIGN container, and BUSINESS PROCESS container, and the like. In one instance, the process instance 342 can include, but is not limited to, context 344, activity 346, and the like.

Activity metric 350 can be a measurement associated with external activity 362. Metric 350 can include, but is not limited to, number of activities performed, change metrics, and the like. For example, metric 350 can include the number of times a step is deleted from an instance to determine a recommendation for deletion of the step from workflow 372. In one embodiment, metric 350 can include metrics obtained from workflow tooling 374, device 360, and the like.

Reconfiguration recommendation 352 can be an automatically generated suggestion for optimizing workflow 372 and/or instances 342. Recommendation 352 can include, but is not limited to, a recommended action, a user identifier, a workflow identifier, and the like. Recommendation 352 can include one or more proposed optimization. In one instance, recommendation 352 can be associated with a ranking, a priority, and the like.

Integrated context 354 can be a data structure for representing an aggregate context across multiple heterogeneous workflow containers. Context 352 can include, but is not limited to, inputs, outputs, user actions, application states, workflow states, and the like. In one embodiment, context 354 can include manually and automatically captured context 344.

Data store 330 can be a hardware/software component able to reconfiguration mapping 332, metric 350, recommendation 352, context 354, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Reconfiguration mapping 332 can be a data set for tracking optimization changes to one or more workflows. Mapping 332 can include, but is not limited to, a workflow identifier, a container identifier, a process identifier, a reconfiguration identifier, and the like. For example, entry 334 can be utilized to associate a workflow optimization (e.g., Reconfig_A) with a container (e.g., Container_A) and a set of processes (e.g., Process_A, Process_B) which have been optimized. In one embodiment, mapping 332 can be dynamically maintained by engine 320.

Computing device 360 can be a hardware/software permitting the execution external activity 32 and/or workflow tooling 374. Device 360 can include, but is not limited to, input/output components, user settings, interface 366, and the like. Computing device 360 can include, but is not limited to, a desktop computer, a laptop computer, a tablet computing device, a PDA, a mobile phone, and the like. Interface 366 can be a user interactive component permitting interaction and/or presentation of activity 362 and/or recommendation 352. Interface 366 capabilities can include a graphical user interface (GUI), voice user interface (VUI), mixed-mode interface, and the like. In one instance, interface 334 can be communicatively linked to computing device 360.

Workflow server 370 can be a hardware/software entity for executing and/or persisting workflow 372. Server 370 functionality can include, but is not limited to, workflow management, workflow policy enforcement, and the like. Server 370 can include, but is not limited to, workflow 372, workflow tooling 374, and the like. In one instance, engine 320 can be a functionality of server 370. In one embodiment, serve r370 can include a runtime environment which can execute workflow container 340. Tooling 374 can include an IBM BUSINESS PROCESS MANAGER software.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), VPN and the like.

Drawings presented herein are for illustrative purposes only and should not be construed to limit the invention in any regard. It should be appreciated that runtime engine 324 can be an optional component of engine 320. It should be appreciated that one or more components within system 300 can be optional components permitting that the disclosure functionality be retained. It should be understood that engine 320 components can be optional components providing that engine 320 functionality is maintained. It should be appreciated that one or more components of engine 320 can be combined and/or separated based on functionality, usage, and the like. System 300 can conform to a Service Oriented Architecture (SOA), Representational State Transfer (REST) architecture, and the like.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for dynamic workflow optimization comprising:
identifying a plurality of heterogeneous process workflow containers within a runtime environment, wherein each of the process workflow containers comprises of at least one process instance, wherein the at least process instance is associated with a workflow, wherein each process instance comprises of at least one of a plurality of activities and a decision point conforming to a business process model;
capturing a plurality of automated and manual changes to at least one activity of a plurality of process instances associated with the workflow executing within the plurality of process workflow containers;
analyzing the changes to establish an integrated context for the at least one process instance, wherein the context comprises of at least one of an input and an output element of the process instance; and
computing a recommendation for optimizing the workflow based on the analyzing.

2. The method of claim 1, further comprising:
presenting the recommendation within a user interface associated with a business process management tooling.

3. The method of claim 1, further comprising:
determining a repeatable pattern from the plurality of automated and manual changes, wherein the repeatable pattern is an input for an optimization recommendation computation.

4. The method of claim 1, wherein the recommendation is at least one of a workflow creation, workflow deletion, and workflow modification.

5. The method of claim 1, wherein the recommendation is at least one of a step insertion, step modification, and step deletion of the process instance.

6. The method of claim 1, wherein the recommendation is computed from at least one of a user preference and a user defined flow, wherein the at least one user preference and user defined flow is associated with a user previously interacting with the process instance.

7. The method of claim 1, further comprising:
applying the recommendation to the plurality of process instances executing within the plurality of process workflow containers.

8. The method of claim 1, further comprising:
automatically assigning ownership of individual activities in the workflow to an actor based on a behavior learned from a plurality of historic activities within the runtime environment.

9. The method of claim 1, further comprising:
forcing parallel activities within the workflow to become sequential activities based on a behavior learned from a plurality of historic activities within the runtime environment.

10. A system for dynamic workflow optimization comprising:
an optimization engine configured to determine an integrated context for a plurality of process instances executing within a plurality of heterogeneous process workflow containers, wherein the context comprises of at least one of an input and an output element of the process instance, wherein the plurality of process instances is associated with a workflow, wherein the workflow is a series of activities conforming to a business process model; and
a data store able to persist at least one of a workflow reconfiguration, an external activity metric, and a reconfiguration mapping, wherein the reconfiguration mapping comprises of at least one of a workflow identifier, a process container identifier, and a change configuration identifier.

11. The system of claim 10, further comprising:
a feedback collector able to capture a plurality of automated and manual changes to at least one step of a plurality of process instances executing within the plurality of process workflow containers;
a workflow analyzer configured to analyze the changes to establish an integrated context for the process instance, wherein the context comprises of at least one of an input and an output element of the process instance; and
a workflow optimizer configured to compute a recommendation for optimizing the workflow based on the analyzing.

12. The system of claim 10, further comprising:
the engine configured to dynamically combine a plurality of activities associated with a workflow responsive to the analyzing.

13. The system of claim 10, further comprising:
the engine able to dynamically merge a plurality of workflows within a runtime environment into a composite workflow responsive to the analyzing.

14. The system of claim 10, further comprising:
the engine configured to notify an administrative entity responsive to detecting abnormal patterns within the plurality of process instances.

15. The system of claim 10, further comprising:
the engine able to propagate at least one of a plurality of changes associated with a process instance within a business process execution model to a workflow associated with a process modeler tooling, wherein the at least one of a plurality of changes conforms to a business process modeling language.

16. The system of claim 10, further comprising:
the engine configured to present the recommendation within a user interface associated with a business process management tooling.

17. The system of claim 10, further comprising:
the engine able to determine a repeatable pattern from the plurality of automated and manual changes, wherein the repeatable pattern is an input for an optimization recommendation computation.

18. A computer program product comprising a computer readable storage medium having computer usable program code embodied therewith, the computer usable program code comprising:
computer usable program code stored in a storage medium, if said computer usable program code is executed by a processor it is operable to identify a plurality of heterogeneous process workflow containers within a runtime environment, wherein each of the process workflow containers comprises of at least one process instance associated with a workflow, wherein each process instance comprises of a plurality of activities;
computer usable program code stored in a storage medium, if said computer usable program code is executed by a processor it is operable to capture a plurality of automated and manual changes to at least one step of a plurality of process instances associated with the workflow executing within the plurality of process workflow containers;
computer usable program code stored in a storage medium, if said computer usable program code is executed by a processor it is operable to analyze the changes to establish an integrated context for the process instance, wherein the context comprises of at least one of an input and an output element of the process instance; and
computer usable program code stored in a storage medium, if said computer usable program code is executed by a processor it is operable to compute a recommendation for optimizing the workflow based on the analyzing.

19. The computer program product of claim 18, wherein the product is at least one of an IBM BUSINESS PROCESS MODELER and an IBM BUSINESS PROCESS MANAGER.

20. The computer program product of claim 18, further comprising:
the computer program product able to present the recommendation within a user interface associated with a business process management tooling.
